(19) United States
(12) Patent Application Publication
(10) Pub. No.: US 2014/0142978 A1
(43) Pub. Date: May 22, 2014

(54) SYSTEMS AND METHODS FOR ASSESSING A LIKELIHOOD OF ELECTIVE SURGERY

(71) Applicant: WELVIE, LLC, St. Louis, MO (US)

(72) Inventors: James Blendell, JR., Delmar, NY (US); Timothy Kotas, Pullman, MI (US)

(73) Assignee: WELVIE, LLC, St. Louis, MO (US)

(21) Appl. No.: 13/683,772

(22) Filed: Nov. 21, 2012

(51) Int. Cl. G06F 19/00

(52) U.S. Cl. CPC G06F 19/3431
USPC 705/3

(57) ABSTRACT

A method and system of assessing a likelihood of an individual having an elective surgery includes retrieving data for the individual from one or more databases. The retrieved data includes one or more data types selected from the following: medical claims data; demographic data; geographic data; drug utilization data; behavioral health data; surgery data; and health literacy data. The method also includes processing the retrieved data to generate an index for the individual. The generated index represents the likelihood of an individual having an elective surgery. Additional methods and related computer systems are also disclosed.

### FIELD

The present disclosure relates to systems and methods for assessing a likelihood of elective surgery.

### BACKGROUND

This section provides background information related to the present disclosure which is not necessarily prior art.

Management of illnesses is a complicated and difficult endeavor. There are currently many methods for assessing and preventing diseases, determining and providing the correct course of treatment, and evaluating best practices. However, the number of diseases and approaches to managing cost and treatment can make the evaluation process difficult because program results occur over an extended period of time and are exposed to outside factors.

While there are many approaches to disease management, the same is not true of surgery management. Traditionally, managing excess health care utilization (including elective surgeries) restricts utilization review to a period of time after an event has begun, or sometimes even after an elective surgery is completed.

Health plans have implemented predictive modeling as a way of identifying members who should be included in disease management programs. The programs typically include disease specific communications or clinical management. Insurance carriers are now beginning to deploy similar techniques on areas such as lower back pain, heart issues and other common ailments.

It is estimated that more than 25% of all elective (not involving medical emergencies) surgeries are unnecessary. While the other seventy-five percent are necessary, significant clinical risk and cost can be avoided through optimization.

### SUMMARY

This section provides a general summary of the disclosure, and is not a comprehensive disclosure of its full scope or all of its features.

According to one aspect of the present disclosure, a method of assessing a likelihood of an individual having an elective surgery is disclosed. The method includes retrieving data for the individual from one or more databases. The retrieved data includes one or more data types selected from the following: medical claims data; demographic data; geographic data; drug utilization data; behavioral health data; surgery data; and health literacy data. The method also includes processing the retrieved data to generate an index for the individual. The generated index represents the likelihood of the individual having an elective surgery.

According to another aspect of the present disclosure, a computer system for assessing a likelihood of an individual having an elective surgery is disclosed. The computer system includes at least one processor, at least one memory device, one or more databases stored in the memory device, and computer-executable instructions stored in the memory device. The computer-executable instructions are operable to cause the processor to retrieve data for the individual from the one or more databases. The retrieved data includes one or more data types selected from the following: medical claims data; demographic data; geographic data; drug utilization data; behavioral health data; surgery data; and health literacy data. The computer-executable instructions are also operable to cause the processor to process the retrieved data to generate an index for the individual. The index represents the likelihood of the individual having an elective surgery.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram representing a method of generating an index for a surgery category according to one aspect of the present disclosure.

FIG. 2 is a block diagram of a computer system for assessing a likelihood of an individual having an elective surgery according to another example embodiment of the present disclosure.

FIG. 3 is a chart illustrating generated indexes for an individual for example surgery categories according to another example embodiment.

FIG. 4 is a chart illustrating the likelihood of future elective surgery based on benchmark data according to another example embodiment.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

According to one aspect of the present disclosure, a method of assessing a likelihood of an individual having an elective surgery is disclosed. The method includes retrieving data for the individual from one or more databases. The retrieved data includes one or more data types selected from the following: medical claims data; demographic data; geographic data; drug utilization data; behavioral health data; surgery data; and health literacy data. The method also includes processing the retrieved data to generate an index for the individual. The generated index represents the likelihood of the individual having an elective surgery.

The generated index may be a number, or may be any other type of indicator or value capable of representing the likelihood of an individual having an elective surgery. The generated index may be compared to a benchmark from person(s) who have previously undergone an elective surgery to evaluate the likelihood of the individual having the same elective surgery. If the generated index is greater than the benchmark, it may indicate a greater likelihood of the individual having the same elective surgery. On the other hand, if the generated index is less than the benchmark, it may indicate a lower likelihood of the individual having the elective surgery. Additionally, or alternatively, the generated index for the individual may be compared to a generated index for another individual to assess the extent to which one of the individuals is more likely than the other to have an elective surgery.

The index may be used to estimate a future elective surgery cost for an individual. A greater index may indicate a greater future elective surgery cost for an individual, while a lesser index may indicate a lesser future elective surgery cost. The generated index may allow an evaluator to quickly and accurately determine the likelihood of the individual having the elective surgery, and therefore the estimated future elective surgery cost for the individual.

The data used in the databases may be primarily based on a combination of data available to health insurance companies. Medical claims data may include the frequency of healthcare service claims, dates of service of claims, etc. Demographic data may include the individual's age, sex, race, etc. Geographic data may incorporate data from the Dartmouth Atlas, other studies showing regional variations in practice patterns for certain surgeries and diseases, etc. Variances may be recorded down to the state, county, zip code, other geographic region sizes, etc. Drug utilization data may include the combination of prescription drug use, frequency, duration, etc. Behavioral health data may include unique behavioral indicators that indicate likelihood for particular surgeries, propensity for acting on surgery recommendations, surgery recurrence, outcome, etc. Surgery data may include an individual's history of surgical procedures. Health literacy data may include information about an individual's level of understanding of surgical procedures, surgery in general, etc. It should be understood that these are only examples of the types of information that may be included in each database and any other types of information which are considered relevant to a specific data type may also be included in that database. Additionally, each database is not required to contain all of the types of information listed in the examples above.

The retrieved data may include data from any number of the data types. The retrieved data may include data from only one of the data types, from any combination of two, three, four, five, or six of the data types, from all of the data types, etc. In one example, only medical claims data may be retrieved and processed to generate the index for the individual. In another example, drug utilization data and behavioral health data may be retrieved and processed to generate the index for the individual. In yet another example, medical claims data, demographic data, geographic data, drug utilization data, behavioral health data, surgery data, and health literacy data may be retrieved and processed to generate the index for the individual.

Elective surgeries may be divided into elective surgery categories. Example elective surgery categories may include one or more of the following: AAA; adenoids; adhesion lysis; appendectomy; bariatric; bladder suspension; breast biopsy; bronchoscopy; bunionectomy; C-section delivery; CABG; cardiac catheterization; cardiac valve procedures; carotid endarterectomy; carpal tunnel; colon restrictions; colonoscopy; combo EGD-colonoscopy; coronary angioplasty with stenting; cystoscopy; cystoscopy—diagnostic only; D&C; dorsal column stimulator; EGD; gallbladder; general shoulder surgery; groin hernia; hemorrhoidectomy; hip replacement; hysterectomy; hysteroscopic procedures; knee arthroscopy; knee ligament reconstruction; knee replacement; laparoscopic nissen; lower extremity bypass; lumpectomy; lung surgery; mastectomy; minimally invasive cardiac; myringotomy; pacemaker/defibrillator; prostate biopsy; prostatectomy; shoulder arthroscopy; shoulder replacement; sinus surgery; sinus surgery—diagnostic; spine basic; spine—disc replacement; spine fusion; thoracoscopy; tonsils; tubal ligation; vaginal delivery; vasectomy/vasovasostomy; ventral hernia repair, etc. It should be understood that these are only example surgery categories and that other categories may be used.

The generated index may represent the likelihood of the individual having an elective surgery in a specific one of the elective surgery categories. For example, the generated index may represent the likelihood of the individual having an elective lung surgery. Another generated index may represent the likelihood of the individual having an elective general shoulder surgery. Alternatively, the generated index may represent the likelihood of the individual having an elective surgery in any one of multiple elective surgery categories. For example, the generated index may represent the likelihood that the individual will have any elective surgery from the categories listed above.

The retrieved data may be processed to generate a plurality of category indexes. In that case, each category index may correspond to a different elective surgery category and represent the likelihood of an individual having an elective surgery in the corresponding elective surgery category. For example, separate category indexes may be generated individually for all of the surgery categories listed above. In this example, a category index may be generated representing the likelihood of the individual having an elective AAA surgery. Another category index may be generated representing the likelihood of the individual having an elective adenoids surgery. Yet another category index may be generated representing the likelihood of the individual having an elective adhesion lysis surgery. This process may be repeated until a category index is generated for all elective surgery categories.

Two or more category indexes may be combined to produce an overall index using any suitable method of combination, such as a simple sum, complex algorithm, etc. The overall index represents the likelihood of the individual having an elective surgery in any of the two or more elective surgery categories. For example, separately generated category indexes representing the likelihood of an elective knee replacement surgery, elective sinus surgery, elective lung surgery, and all other elective surgery categories listed above may be combined to produce an overall index. This overall index may represent the likelihood of the individual having an elective surgery in any one of the surgery categories listed above. Overall indexes may be used by evaluators to determine the likelihood of any future elective surgery, while category indexes may be used to determine the likelihood of specific types of future elective surgery.

A risk mitigation plan may also be prepared to reduce the likelihood of the individual having a non-optimal elective surgery outcome. The risk mitigation plan may be based on a single intervention or a combination of different interventions, where the interventions may each be designed to assist in an optimal elective surgery outcome. There may be any suitable number of possible interventions to select from, and could be as many as one thousand or more different possible interventions. The proper combination of interventions may be dictated by one or more indexes generated for the individual. For example, interventions related to assisting in optimal elective hip replacement surgery outcomes may be dictated if the individual has a relatively high index for elective hip replacement surgery.

The risk mitigation plan may include advising an individual regarding an alternative surgery, advising the individual regarding an alternative therapy, educating the individual regarding the elective surgery, etc. A database may include content related to any suitable number of elective surgeries, and may contain content related to, e.g., 180 elective surgeries. The content may include detailed treatments, risks, recoveries, outcomes, etc., for the elective surgeries. Information may be given to individuals, possibly through a website, which includes detailed surgery animations that show how a given elective surgery is performed. Information may also be given which provides a complete list of alternatives to an elective surgery. The alternatives may include less invasive surgery, conservative therapy, drug therapy, etc. If implemented properly and followed correctly, a successful risk mitigation plan may reduce the risks related to the elective surgery for the individual. For example, a risk mitigation plan may be generated for an individual with a generated index indicating a high likelihood of elective knee replacement surgery. The risk mitigation plan may involve detailed surgery animations that show how a knee replacement surgery is performed. The risk mitigation plan may also involve providing the individual with a complete list of alternatives to knee replacement surgery, such as less invasive surgery, conservative therapy, drug therapy, etc. If implemented properly, the risk mitigation plan may reduce the risks for the individual (and costs) related to the elective knee replacement surgery.

The risk mitigation plan may involve a case management clinical team that designs a treatment plan based on best practices to ensure patients get the most efficient care. The risk mitigation plan may also involve a provider relations team that engages a provider to conduct treatments in line with a best practices model. The risk mitigation plan may also involve a pharmacist support team because their knowledge of drugs and drug therapies can be a great tool in assisting patients with drug therapies and drug compliance initiatives. Targeted communications (i.e., letters, emails, telephone calls, personal visits, etc.) may also be used to provide surgery candidates with material that will lead the candidates to seek more detailed information to begin the surgery education process. Incentive packages may also be offered to ensure individuals remain in a program long enough to get a thorough understanding of their illness. It may be necessary to offer different types of incentives as a method of ensuring program completion. Upon identification of a high risk individual, several options may be available to positively influence future events, and varying levels of education, communication, engagement and intervention can be conducted to achieve a more favorable outcome.

Cost savings may also be estimated related to the interventions. The costs of the implementation, effects, expected outcome, etc., of the intervention(s) may be compared to the expected costs of the individual having the elective surgery without any intervention to determine the cost savings. The estimated costs savings of the intervention may be compared to the costs of the intervention to calculate a return on investment (ROI). The ROI may allow an evaluator to determine whether intervention(s) should be used in a particular case. Data may be retrieved which includes health literacy data, and an index may be generated which represents the likelihood of the individual having an elective surgery with a non-optimal outcome. An individual with a low level of health literacy may have a greater likelihood of having a non-optimal elective surgery outcome.

Data may also be retrieved from the databases for a group of individuals in a population. The retrieved data may be processed to generate an index for each individual in the population. Each generated index may represent the likelihood that the associated individual in the population will have elective surgery. For example, the population may be subscribers to a certain health plan. Data may be retrieved for a group of individuals who are subscribers in the health plan. The retrieved data may be processed to generate a separate index for each individual who is a subscriber in the health plan, with each generated index indicating the likelihood that the associated individual will have an elective surgery. This may allow an evaluator to quickly and accurately determine the likelihood of elective surgery for each member of a certain health plan.

The individual indexes may also be combined to produce a group index for the population. The group index may represent the likelihood that one or more individuals in the population will have elective surgery. For example, where separate indexes have been generated for each member belonging to a health plan, the indexes may be combined to produce a group index which represents the likelihood that one or more individuals belonging to the health plan will have elective surgery. This group index may be used to estimate a future elective surgery cost for the population. For example, the likelihood of individuals from a health plan having one or more elective surgeries may be interpreted along with the cost of the elective surgeries to determine estimated future elective surgery costs for the health plan. A greater group index may indicate a relatively higher future elective surgery cost for the population, while a lesser group index may indicate a relatively lower future elective surgery cost for the population. This may allow an evaluator to quickly and accurately determine future elective surgery costs for the health plan.

Indexes may be generated for different time periods and compared to determine any changes between the time periods. A group index for a population may be generated for a first time period by retrieving data, processing the data, generating individual indexes for each member of the population, and combining the indexes for a first time period. This process may be repeated for a second time period. The group index for the first time period may be compared to the group index for the second time period to determine any change between the two time periods in the likelihood of individuals from the population having elective surgery. For example, a group index for a health plan population may be generated to indicate the likelihood of health plan subscribers having elective surgery during a first six month period. Another group index may be generated for the immediately following six month period. The two group indexes may be compared to determine if the likelihood of health plan subscribers having elective surgery has increased, decreased, or stayed the same.

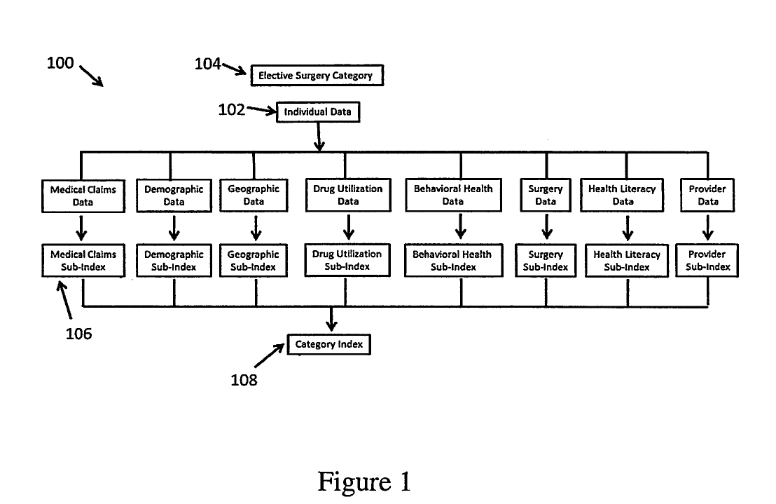

An example method of generating a category index for an individual representing the likelihood that the individual will have an elective surgery in an elective surgery category is illustrated in FIG. 1, and indicated generally by reference number 100. Individual data 102 may be retrieved for the individual from one or more databases. The retrieved data may include one or more data types including medical claims data, demographic data, geographic data, drug utilization data, behavioral health data, surgery data, health literacy data, provider data, etc., as shown in FIG. 1. The elective surgery category 104 may include one or more elective surgeries. The retrieved data may be processed to generate a sub-index 106 for each data type. The sub-indexes 106 may be combined to generate a category index 108 which represents the likelihood that the individual will have an elective surgery in the elective surgery category 104.

The method 100 may be repeated for one or more additional elective surgery categories 104 to generate multiple category indexes 108. The multiple category indexes 108 may be combined to generate an overall index for the individual.

In a population including more than one individual, individual indexes can be combined to generate a group index for the population representing a likelihood that one or more individuals in the population will have an elective surgery. For example, the method 100 may be repeated for each member of the population to generate multiple category indexes 108, which may then be combined to generate a category group index representing the likelihood of one or more individuals in the population having an elective surgery in the elective surgery category 104. Additionally, or alternatively, an overall index may be generated for each individual in the population representing the likelihood of the individual having an elective surgery in two or more (possibly including all) of the elective surgery categories. Further, the overall I indexes generated for members of the population may be combined to generate an overall group index for the population representing the likelihood of one or more individuals in the population having an elective surgery in two or more of the elective surgery categories.

Although FIG. 1 illustrates eight data types, it should be understood that more, less and/or other data types may be used. In addition to the data types described above, primary care provider data may also be used and may include information related to provider patient history, surgeries, claims, etc.

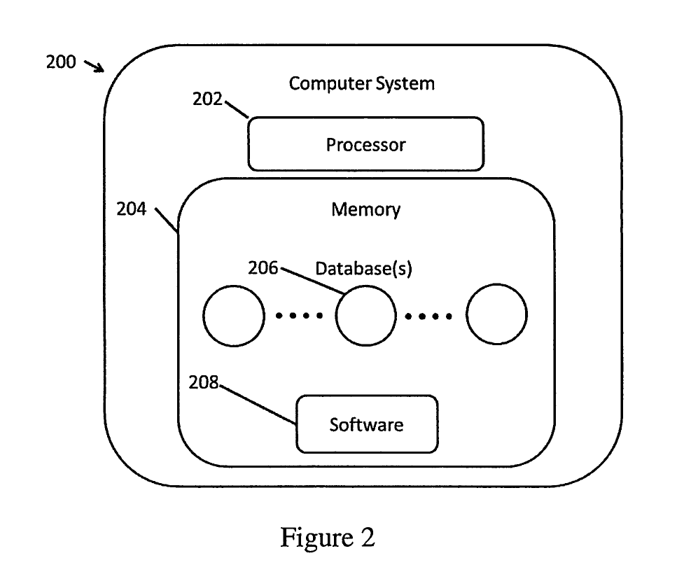

FIG. 2 illustrates a computer system 200 for assessing a likelihood of an individual having an elective surgery according to another example embodiment of this disclosure. The computer system 200 includes at least one processor 202, a memory device 204, one or more databases 206 stored in the memory device 204, and computer-executable instructions (e.g., software) 208. The software 208 is operable to cause the processor to retrieve data for the individual from the one or more databases 206. The retrieved data may include one or more data types selected from the following: medical claims data; demographic data; geographic data; drug utilization data; behavioral health data; surgery data; and health literacy data. The software 208 is also operable to cause the processor 200 to process the retrieved data to generate an index for the individual. The generated index represents the likelihood of the individual having an elective surgery. Additionally, or alternatively, the computer system 200 may be configured to implement other functions.

It should be understood that the system 200 may be implemented in various ways. For example, the system 200 may be implemented on a personal computer, an office network, one or more servers, etc. The system 200 may be implemented using a single processor 202, multiple processors on a single system, or multiple processors across multiple systems. Additionally, the memory device 204 may be located in a single computer, server, etc., and may be shared between multiple systems. The memory device 204 may be located within the same system as one or more of the processors 202 (including onboard memory in the processors), or may be located externally. The memory device 204 may be random access memory or more permanent data storage memory, such as a hard drive. The one or more databases 206 and the software 208 may be stored in any location in the memory device 204 and may or may not be stored in the same memory device.

The data retrieved by the computer system 200 may include data of one or more data types. The software 208 may be operable to cause the processor 202 to process the retrieved data to generate a plurality of indexes. The software 208 may also be operable to cause the processor 202 to combine the plurality of indexes to produce an overall index.

Further, the software 208 may be operable to cause the processor 202 to prepare a risk mitigation plan to reduce the likelihood of the individual having a non-optimal elective surgery outcome.

The software 208 may be operable to cause the processor 202 to retrieve data for a plurality of individuals in a population from the one or more databases. The software 208 may also be operable to cause the processor 202 to process the retrieved data to generate an index for each individual in the population. The software 308 may be operable to cause the processor 202 to combine the generated indexes to produce a group index for the population. The software 208 may also be operable to cause the processor 202 to use the group index to estimate a future elective surgery cost for the population.

The software 208 may be operable to cause the processor 202 to retrieve, process, and combine indexes for a first time period to produce a group index for the population for the first time period. The software 208 may also be operable to cause the processor 202 to retrieve, process and combine indexes for a second time period to produce a group index for the population for the second time period. The software 208 may additionally be operable to cause the processor 202 to compare the group index for the first time period with the group index for the second time period to determine any change between the first time period and the second time period in the likelihood that one or more individuals in the population will have elective surgery.

Some aspects of the data types of the present disclosure will be further described. As noted above, medical claims data including a history of medical claims for the individual may be retrieved. Diagnosis codes of the medical claims may be processed based on the relevance of each code to a particular elective surgery (or elective surgery category). The relevance may be determined by referencing a relevance database developed though researching the relationship between particular medical claims data and a particular elective surgery (or category) using a large amount of collected historical data. For example, certain medical claims related to back issues may be strong indicators that an individual will have elective back surgery in the near future. The relevance database may include numerical values correlating certain medical claims to the likelihood of a future elective surgery. Each retrieved medical claim and/or diagnosis code may be assigned a numerical relevance to one or more elective surgeries.

The history of medical claims data retrieved for the individual may be grouped according to a claims analysis duration based on the typical time a patient will be in treatment prior to a particular surgery, which may be referred to as an episode. For example, if back surgery patients typically have symptoms during the six months leading up to an elective back surgery, the claims analysis duration may be six months for elective back surgery. After the medical claims are processed by their relevance and total number of incidents, they may be summed to generate a sub-index for the individual specific to medical claims data for the particular surgery (or category). This can be compared to benchmark data of similar patients who have had that particular elective surgery (or an elective surgery from the same category) to determine a likelihood of the present individual having the elective surgery in the future. The benchmark data may also be based on a database having large amounts of collected historical data of patients who have had the specific elective surgery (or an elective surgery from the same category). For example, if a sub-index is generated for the individual based on medical claims data related to elective back surgery, it may be compared to a benchmark of patients who previously had elective back surgery. If the individual's sub-index is greater than the benchmark, the relative likelihood of future elective back surgery for the individual may be high, but if the sub-index is less than the benchmark, the relative likelihood of back surgery may be low.

Behavioral health data may also be retrieved for the individual. The relative likelihood of future elective surgery for patients having a behavioral health diagnosis is greater than the likelihood of future elective surgery for patients without a behavioral health diagnosis. Behavioral health data may include historical medical data from claims, data on use of drugs whose primary indication is related to behavioral health, etc. The behavioral health data may be processed based on relevance to indicating a future elective surgery using the process described above to generate a sub-index. The sub-index may be compared to benchmark data of similar patients who have had the particular elective surgery (or an elective surgery from the same category) and also had behavioral health illness to determine the likelihood of the present individual having an elective surgery in the future. Diagnosis codes of behavioral illness, prescription drug claims for drugs related to mental illness, etc., may also be used to generate an index for an individual based on behavioral health data.

Drug utilization data may also be retrieved for an individual. Drug use for medical treatment may be correlated to an indication of likelihood of a future elective surgery. After the drug utilization data is processed to determine the relevance of each drug used by the individual to a particular elective surgery (or category) using the process described above, a sub-index may be generated for the individual specific to drug use data for the particular elective surgery (or category). The sub-index can be compared to benchmark drug utilization data of similar patients who have had that particular elective surgery (or an elective surgery from the same category) to determine the likelihood of the present individual having an elective surgery in the future.

A past history of surgery can greatly affect the likelihood that an individual will have future elective surgery. Data may be retrieved related to the individual's past history of surgeries. The surgery data may indicate past surgery with a high rate of recidivism based on surgery complexity, a patient's health, low success rate of the surgery, etc. The surgery data may also indicate diagnostic surgery, which may be necessary to properly diagnose some diseases and illness. These types of surgery data may be processed for their relevance to a particular elective surgery (or elective surgery category). After the surgery data is processed for the relevance of the past surgery or surgeries to a particular elective surgery (or elective surgery category), a sub-index may be generated for the individual specific to surgery data for a particular elective surgery (or surgery category). This can be compared to benchmark surgery data of similar patients who have had that particular elective surgery (or an elective surgery from the same category) to determine the likelihood of the present individual having an elective surgery in the future.

Surgery literacy data relates to the amount of information a patient knows about surgery and wellness. Several studies have shown that an individual's knowledge of health care and surgeries will affect their willingness to explore non-surgical therapies. Additionally, patients with higher health literacy have fewer complications, shorter lengths of stay, and a higher success rate. Data may be retrieved about an individual's level of surgery awareness and the individual may be given a sub-index based on this level. The sub-index may indicate the likelihood of an individual having an elective surgery based on their health literacy level.

Demographic data may be retrieved for an individual. For many elective surgeries (or elective surgery categories), age or gender affects the likelihood of an individual having an elective surgery in the future. The demographic data may be processed to generate a sub-index indicating the likelihood of an individual having an elective surgery in the future.

Geographic data may also be retrieved for an individual. Surgery patterns may vary by region. The geographic data may be processed based on the location of the individual to generate a sub-index representing the likelihood of an individual from that location having an elective surgery. The geographic data may be compiled from the Dartmouth Atlas of Health Care, Medicare hospital claims, commercial and public sector patients, inpatient and outpatient settings, etc. Variances may be recorded down to the state, county, zip code, etc.

Referring again to FIG. 1, once a sub-index 106 is generated for the individual for each of the data types in which data for the individual could be retrieved, a category index 108 may be generated by combining the separate sub-indexes for each data type. Because the individual may not have available data corresponding to each data type, the sub-indexes 106 for each data type may be calibrated to indicate similar levels of likelihood of future elective surgery. The category index 108 indicates the likelihood of an individual having an elective surgery in the elective surgery category 104 based on individual data 102 retrieved for the individual. The category index 108 may be based on an elective surgery category 104 having one or more elective surgeries. Multiple category indexes 108 may be generated for the individual for multiple surgery categories 104. Finally, the category indexes 108 for multiple surgery categories 104 may be combined to generate an overall index for the individual representing the likelihood of the individual having any elective surgery.

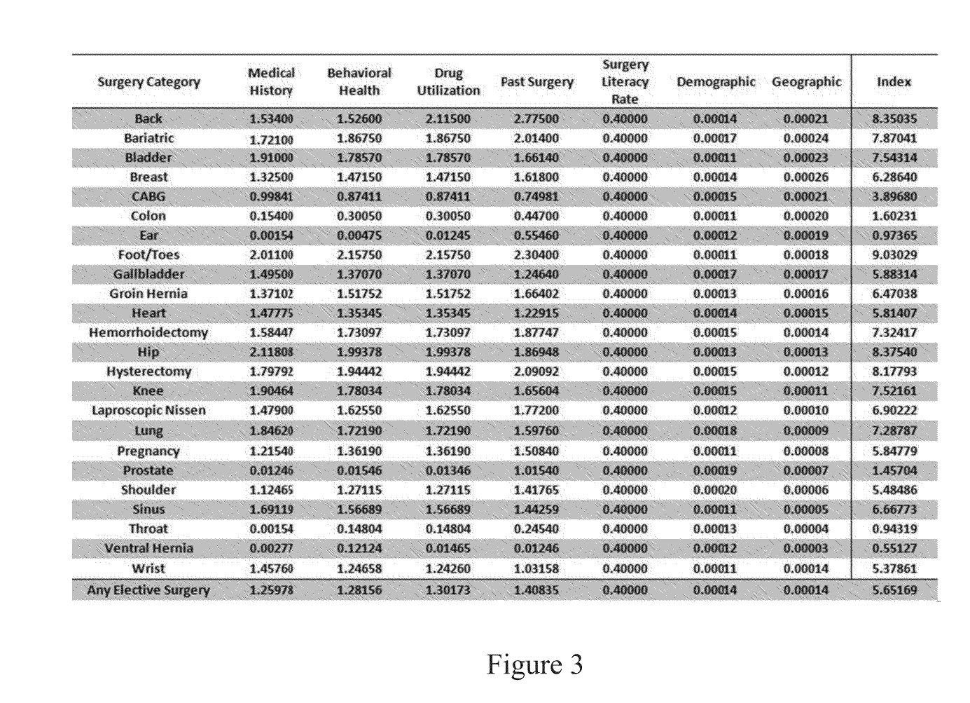

FIG. 3 is an example chart illustrating indexes for one example individual. The first column lists example surgery categories. Each surgery category may include one or more elective surgeries. The second through eighth columns list the data types and the generated sub-indexes for each data type corresponding to each surgery category. Finally, a category index is listed in the last column for each surgery category, representing the likelihood of the individual having an elective surgery from the corresponding surgery category. The category indexes may be generated from a combination of the sub-indexes for each data type for the corresponding surgery category.

Although many individuals may not have sufficient data to generate a sub-index for every data type in every surgery category, sub-indexes for every data type and surgery category are shown here for illustration purposes. In this example, data was retrieved for each data type and processed to generate sub-indexes indicating a likelihood of future elective back surgery. For example, row two, column two of the chart contains a sub-index representing a likelihood of future elective back surgery based on data for the individual related to the individual's medical history. Row two, column three contains a sub-index representing a likelihood of future elective back surgery based on data for the individual related to the individual's behavioral health. This was repeated to generate sub-indexes for each data type. These sub-indexes were then combined to generate the category index for likelihood of future elective back surgery shown in the last column. Next, the data was processed to generate sub-indexes for likelihood of future bariatric surgery, shown in row three. These sub-indexes were also combined to generate the combined index for future bariatric surgery. This was repeated for all surgery categories. Finally, each category index was combined to produce an overall index for the individual indicating the likelihood of the individual having any future elective surgery from any of the categories. The overall index is in the bottom row of the last column.

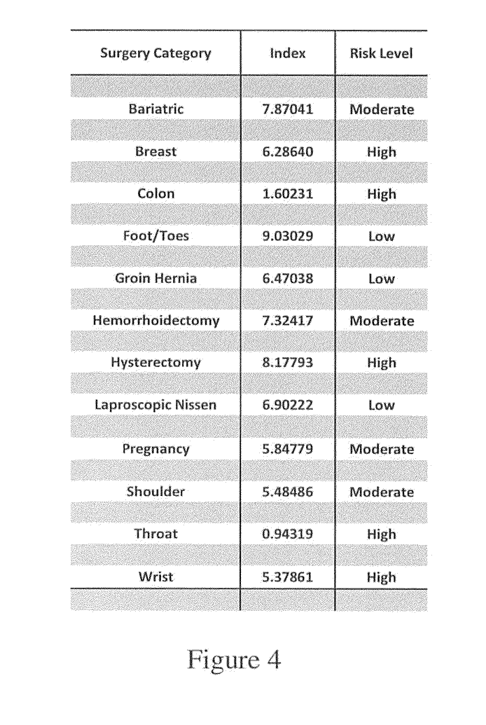

To assist in evaluating each of the raw index values, each of the category indexes may be compared against benchmark data of other patients who have had a specific elective surgery (or an elective surgery from the same category) to determine the likelihood that the present individual will have the specific elective surgery (or an elective surgery from the same category) associated with each specific index. FIG. 4 is an example chart illustrating the likelihood (also called risk level) of an individual having an elective surgery based on comparing their generated category indexes to benchmark data. The first column lists the example surgery categories. The second column lists the category index for the individual for each surgery category. The category indexes used in FIG. 4 are those generated according to FIG. 3. The last column indicates the likelihood or risk level of the individual having an elective surgery. For example, when the category index generated for elective back surgery is compared to the benchmark data, it indicates a high likelihood of future elective back surgery. When the category index generated for elective bariatric surgery generated index is compared to benchmark data, it indicates a moderate likelihood of future elective bariatric surgery. When the generated category index for elective CABG surgery is compared to benchmark data, it indicates a low likelihood of future elective CABG surgery. The overall index for the individual may also be compared to a benchmark to indicate the likelihood of the individual having any elective surgery from any of the elective surgery categories. This is illustrated in the bottom row of the chart.

In another example of the present disclosure, a patient may have a lengthy claims history with many doctor visits that are not specifically related to back pain or discomfort. The patient has no instance of mental illness and a prescription drug history only related to acute ailments (flu, strep throat, etc.). The patient doesn't have a primary care provider with a patient history that is significantly skewed toward back surgeries. This example patient may have a low category index for likelihood of elective back surgery, but may have higher indexes for likelihood of other surgeries. With a relatively low likelihood of elective back surgery, there is likely no need for elective back surgery specific programmatic intervention. However, some other indexes may display inefficiencies and indicate the need for an intervention to prevent future risk. If the patient has a high demographic sub-index combined with a lack of surgery literacy sub-index, the risk mitigation plan for this patient may include shared decision making or basic literacy programming.

In another example of the present disclosure, a patient may have a limited claims history, but the history may have a high incidence of codes that are common prior to elective back surgery. The patient may have a recent prescription for pain medications and a primary care provider whose patient population has a higher percentage of back surgery than average. This patient may also be in a geographic location that has a significantly higher rate of back surgeries than the national average. Thus, the patient may have a very high category index for likelihood of elective back surgery. The risk mitigation plan for this patient may include interventions that focus on successful surgery and recovery techniques for back surgery. Additionally, if the patient is not already engaged though a care management program or team, that may also be initiated.

In another example of the present disclosure, a patient may be a 47 year old woman who has seen a medical provider who suggested she may need to have a hysterectomy based on a diagnosis of her symptoms. The patient may have been going to her doctor for pain and discomfort related to uterine fibroids and may have had several visits over a three month period. Given her medical history, age, demographics and other factors, her category index related to the likelihood of having an elective hysterectomy surgery may be high. While the category index may be high, it doesn't appear that her elective surgery is imminent, so a risk mitigation plan for this patient may include shared decision making or education promoting alternatives to surgery, conservative options such as lifestyle changes or drug therapies, and less invasive surgery alternatives. An intervention by a pharmacist or pharmacy team may be scheduled.

In another example of the present disclosure, a patient may be a 52 year old woman who has been going to her doctor for excessive vaginal bleeding and has several visits over a six month period. Given her medical history, age, demographics and other factors, her category index related to the likelihood of having a hysterectomy elective surgery may be high. It appears that this patient is likely to have elective surgery within the near future, so the patient's risk mitigation plan may assist in efficient surgery and successful recovery and not focus on material that will suggest alternatives to surgery.

In another example of the present disclosure, a small health plan may have a relatively idle population with little increase or decrease in membership. A group index may be generated for the group based on data from the previous two year period. The population may have an overall group index showing a moderate level of likelihood of all elective surgeries. While this may be a relatively strong overall group index when compared to similar populations, there may be several specific areas of concern. The population may have a high category group index in a heart surgery category indicating a likelihood of future elective heart surgery. It may appear that in this population there is a high ratio of treatments including the use of artery stents, instead of drug therapy including statins. The risk mitigation plan may be implemented through the health plan's provider relations department, and may take action to address the problem by using intensive provider education created by the pharmacy team around best practices related to the most efficient forms of heart surgery and also alternative therapies.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-25. (canceled)

26. A computer system for assessing a likelihood of an individual having an elective surgery, the computer system comprising:
at least one processor;
at least one memory device;
one or more databases stored in the memory device; and
computer-executable instructions stored in the memory device and operable to cause the processor to retrieve data for the individual from the one or more databases, the retrieved data including one or more data types selected from the following: medical claims data; demographic data; geographic data; drug utilization data; behavioral health data; surgery data; and health literacy data; and the computer-executable instructions operable to cause the processor to process the retrieved data to generate an index for the individual, wherein the generated index represents the likelihood of the individual having an elective surgery.

27. The computer system of claim 26 wherein a plurality of different elective surgeries are divided into a plurality of elective surgery categories, and wherein the generated index represents the likelihood of the individual having an elective surgery in a specific one of the elective surgery categories.

28. The computer system of claim 27 wherein the computer-executable instructions are operable to cause the processor to process the retrieved data to generate a plurality of category indexes including said index, each of the plurality of category indexes corresponding to a different one of the elective surgery categories and representing a likelihood of the individual having an elective surgery in the corresponding one of the elective surgery categories.

29. The computer system of claim 28 wherein the computer-executable instructions are operable to cause the processor to combine the plurality of category indexes to produce an overall index, the overall index representing the likelihood of the individual having an elective surgery in any one of the elective surgery categories.

30. The computer system of claim 26 wherein a plurality of different elective surgeries are divided into a plurality of elective surgery categories, and the generated index represents the likelihood of the individual having an elective surgery in any one of the elective surgery categories.

31. The computer system of claim 30 wherein the plurality of elective surgery categories are selected from the group consisting of back, bariatric, bladder, breast, CABG, colon, ear, foot/toes, gallbladder, groin hernia, heart, hemorrhoidectomy, hip, hysterectomy, knee, laparoscopic nissen, lung, pregnancy, prostrate, shoulder, sinus, throat, ventral hernia and wrist.

32. The computer system of claim 30 wherein the computer-executable instructions are operable to cause the processor to divide the plurality of different elective surgeries into the plurality of elective surgery categories.

33. The computer system of claim 26 wherein the computer-executable instructions are operable to cause the processor to prepare a risk mitigation plan to reduce the likelihood of the individual having a non-optimal elective surgery outcome.

34. The computer system of claim 33 wherein the risk mitigation plan includes advising the individual regarding an alternative surgery, advising the individual regarding an alternative therapy, and/or educating the individual regarding said elective surgery.

35. The computer system of claim 33 wherein the risk mitigation plan includes estimating a cost savings related to one or more interventions.

36. The computer system of any preceding claim 26 wherein the retrieved data includes health literacy data, and wherein the generated index represents the likelihood of the individual having a non-optimal elective surgery outcome.

37. The computer system of claim 26 wherein the generated index is a number.

38. The computer system of claim 26 wherein the computer-executable instructions are operable to cause the processor to generate an index to estimate a future elective surgery cost for the individual.

39. The computer system of claim 26 wherein the computer-executable instructions are operable to cause the processor to retrieve data for a plurality of individuals in a population from the one or more databases, the plurality of individuals including said individual, and wherein the computer-executable instructions are operable to cause the processor to process the retrieved data to generate an index for each individual in the population, each generated index representing the likelihood that the associated individual in the population will have elective surgery.

40. The computer system of claim 39 wherein the computer-executable instructions are operable to cause the processor to combine the generated indexes to produce a group index for the population, the group index representing a likelihood that one or more individuals in the population will have elective surgery.

41. The computer system of claim 40 wherein the computer-executable instructions are operable to estimate a future elective surgery cost for the population using the group index.

42. The computer system of claim 40 wherein the computer-executable instructions are operable to cause the processor to perform the retrieving, processing and combining during a first time period to produce the group index for the population during the first time period, and the computer-executable instructions are operable to cause the processor to repeat the retrieving, processing and combining during a second time period to produce a group index for the population during the second time period.

43. The computer system of claim 42 wherein the computer-executable instructions are operable to cause the processor to compare the group index for the first time period with the group index for the second time period to determine any change between the first time period and the second time period in the likelihood that one or more individuals in the population will have elective surgery.

44. The computer system of claim 26 wherein the computer-executable instructions are operable to cause the processor to compare the generated index to a benchmark index for one or more persons that have undergone the elective surgery to further evaluate the likelihood of the individual having the elective surgery.

45. The computer system of claim 26 wherein the retrieved data includes two or more of said data types.

46-51. (canceled)
